(19) United States
(12) Patent Application Publication
(10) Pub. No.: US 2011/0282722 A1
(43) Pub. Date: Nov. 17, 2011

(54) NETWORKED REFERRAL SYSTEM

(76) Inventors: Bhanu Chopra, New Delhi (IN); Jan Vernon Tissera, South Melbourne (AU)

(21) Appl. No.: 12/778,856

(22) Filed: May 12, 2010

(51) Int. Cl. G06Q 30/00; G06Q 10/00; G06Q 99/00

(52) U.S. Cl. 705/14.16

(57) ABSTRACT

Method and system for a referral system is provided. The method includes: (a) creating a vendor account for linking a vendor system with the referral system, the vendor system used for offering a vendor product and service; (b) establishing a referral rule based on which a user earns an amount from using the referral system; (c) establishing a threshold value based on which a user is permitted to redeem the amount earned by using the referral system; (d) creating a user account with the referral system that allows the user to electronically refer another entity to buy the vendor product and service; (e) sending an invitation to the another entity on behalf of the user, wherein the referral system sends the invite on the user's behalf with a review of the user's experience with vendor product and service.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This invention is related to computing systems.

### BACKGROUND

The development of the Internet has allowed one to share information easily. Social networking sites today are being used by individuals and businesses across the world. One challenge has been to use such networking sites and systems for business and commercial gain. Continuous efforts are being made to leverage such platforms in business.

### SUMMARY

In one embodiment, a machine implemented method for a referral system is provided. The method includes: (a) creating a vendor account for linking a vendor system with the referral system, the vendor system used for offering a vendor product and service; (b) establishing a referral rule based on which a user earns an amount from using the referral system; (c) establishing a threshold value based on which a user is permitted to redeem the amount earned by using the referral system; (d) creating a user account with the referral system that allows the user to electronically refer another entity to buy the vendor product and service; (e) sending an invitation to the another entity on behalf of the user, wherein the referral system sends the invite on the user's behalf with a review of the user's experience with vendor product and service; (f) based on the referral, crediting the user account, when the other entity makes a purchase of a product, service or both; and (g) redeeming the credited amount if the amount meets the threshold value set by the vendor.

This brief summary has been provided so that the nature of the disclosure may be understood quickly. A more complete understanding of the disclosure can be obtained by reference to the following detailed description of the preferred embodiments thereof in connection with the attached drawings.

### BRIEF DESCRIPTION OF THE DRAWINGS

The foregoing features and other features of the present disclosure will now be described with reference to the drawings of various embodiments. In the drawings, the same components have the same reference numerals. The illustrated embodiments are intended to illustrate, but not to limit the scope of the disclosure. The drawings include the following Figures:

FIG. 1 shows a block diagram of a referral system, according to one embodiment;

FIG. 2 shows a block diagram of the internal architecture of a computing system used in the system of FIG. 1;

FIGS. 3-5 shows process flow diagrams according to one embodiment; and

FIGS. 6A-6J, 7A-7K and 8 show examples of the various processes and systems, used according to the adaptive embodiments disclosed herein;

FIG. 9 shows another process flow diagram, according to one embodiment of the present invention.

### DETAILED DESCRIPTION

To facilitate an understanding of the various embodiments, the general architecture and operation of a referral system will first be described. The specific architecture and operation of the various embodiments will then be described with reference to the general architecture.

As used in this disclosure, the terms “component”, “module”, “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer.

By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

Computer executable components can be stored, for example, on computer readable media including, but not limited to, an ASIC (application specific integrated circuit), CD (compact disc), DVD (digital video disk), ROM (read only memory), floppy disk, hard disk, EEPROM (electrically erasable programmable read only memory) and memory stick and any other type of non-volatile memory in accordance with the claimed subject matter.

Overall System

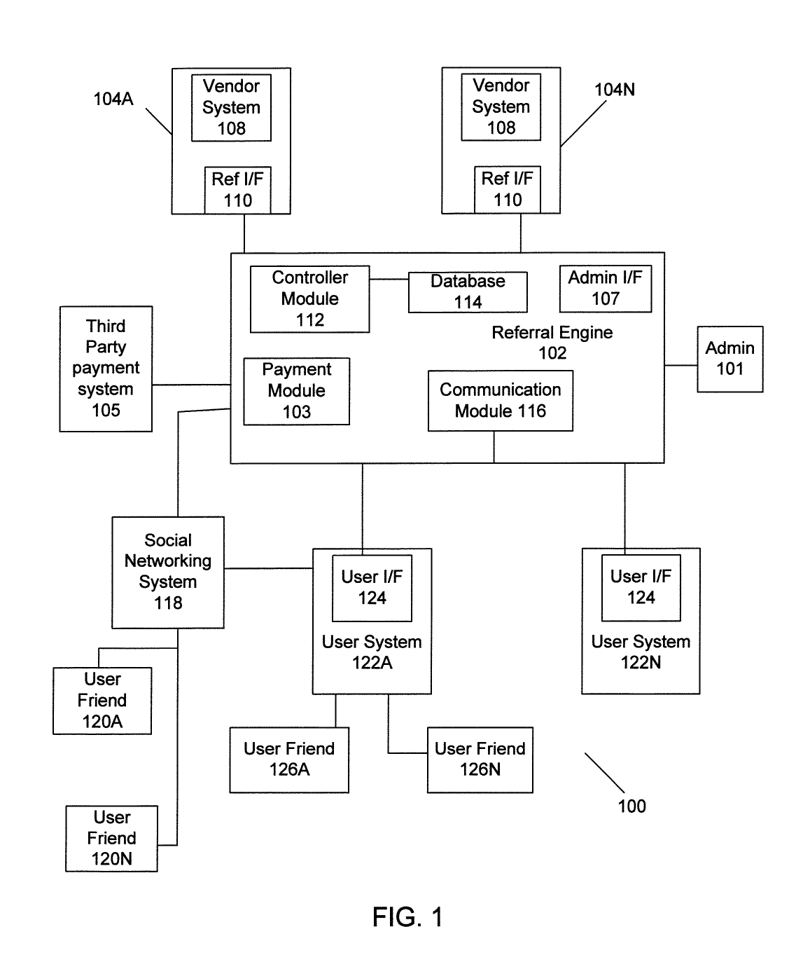

FIG. 1 shows an example of a referral system 100, used according to one embodiment. System 100 includes a referral engine (or module) 102 (may also be referred to as referral system throughout this specification) that includes a controller module 112, a database 114 and a communication module 116. In one embodiment, referral engine 102 may be implemented by one or more processors executing programmable instructions out of a memory.

Referral engine 102 may be managed by an administrator module 101 that interfaces with an administrator interface 107. This allows an authorized entity to manage different aspects and modules of referral engine 102.

Controller module 112 has access to database 114 and performs various functions that are described below in detail. Communication module 116 sends and receives information from other systems, as described below in detail.

Referral engine 102 includes a payment processing module 103 that interfaces with a third party payment system (for example, Paypal) for distributing reward amounts and overall money transfer.

Referral engine 102 interfaces with a plurality of modules including a plurality of vendor modules (may also be referred to as client, customer or seller) 104a-104n (may also be referred to as vendor 104). Vendor module 104 maybe a computing system executing a vendor system 108 for providing products and services. Vendor system 108 may be a vendor controlled automated computerized system or a third party system for buying and selling goods and services. For example, vendor system 108 may be a reservation system for a hotel that may be used by a user to make, cancel and modify hotel reservations using a computer, laptop, personal digital assistant, a mobile phone and other similar devices.

Vendor module 104 may include a referral engine interface 110 for interfacing with referral engine 102 via the communication module 116. In one embodiment, referral engine interface 110 may be an application programming interface (API) that is executed by vendor module 108 and links vendor module 104 with referral engine 102.

Referral engine 102 may also interface with a plurality of user systems 122a-122n (may also be referred to as user 122). User system 122 may be a computing system that is used by a user to communicate with others via a computing network, for example, the Internet. A processor executing programmable instructions may display a user interface 124 on a display device (not shown).

User system 122 may be used to communicate with a plurality of friend's 126a-126n. The term friend as used herein means a computing system executed by a friend to correspond with user system 122. The term computing system includes a personal digital assistant, a cell phone, a laptop computer, a notebook computer, a desktop computer or any other type of computing device/system that may have access to the Internet, for example, electronic reading books (for example, Kindle® provided by Amazon Inc and without derogation of any trademark rights of Amazon Inc), portable devices like the iPOD provided by Apple Inc. and without derogation of any trademark rights of Apple Inc.

In one embodiment, a social networking system 118 may be used by user system 122 to communicate with a plurality of friends' 120a-120n. Social networking system 118 may also interface with referral engine 102 via communication module 116 to provide updates to a user account regarding a product or service (for example, information regarding a user's stay at a hotel), as described below in detail.

Various different types of social networking systems, for example, Facebook, MySpace, LinkedIn, Twitter and others may interface with referral engine 102 and the users.

In one embodiment, referral engine 102 provides a different type of social networking environment that is referred to as “Social Loyalty” through out this application and in the various drawings described below. Under Social Gain, a vendor, for example, a hotel chain or owner, an airline, a car rental company, a cruise line or any travel related organization that provides travel related products and/or services, using a computing system signs up with referral engine 102. A user (or consumer) that has used the vendor's product and/or services also signs up with the referral engine 102. The user becomes a referrer and provides information regarding vendor products and services to user friends either directly or via a social networking site. The referral engine 102 then electronically invites user friends to use the referred vendor product and/or services.

If the invited individual signs up for the product and/or service, then the user earns a certain referral amount based on the referrals rules set by the vendor in the referral engine. Also, a percentage of the transaction goes to the entity that provides referral engine 102. The vendor earns via selling their product and/or service to the invited individual. Hence, use of referral engine 102 benefits everyone in the loop.

Details regarding the processes executed by referral engine 102 are provided below in more detail. Before describing the processes and referral engine 102 in more detail, the following provides a description of a computing system that may be used in various components of FIG. 1.

Computing System:

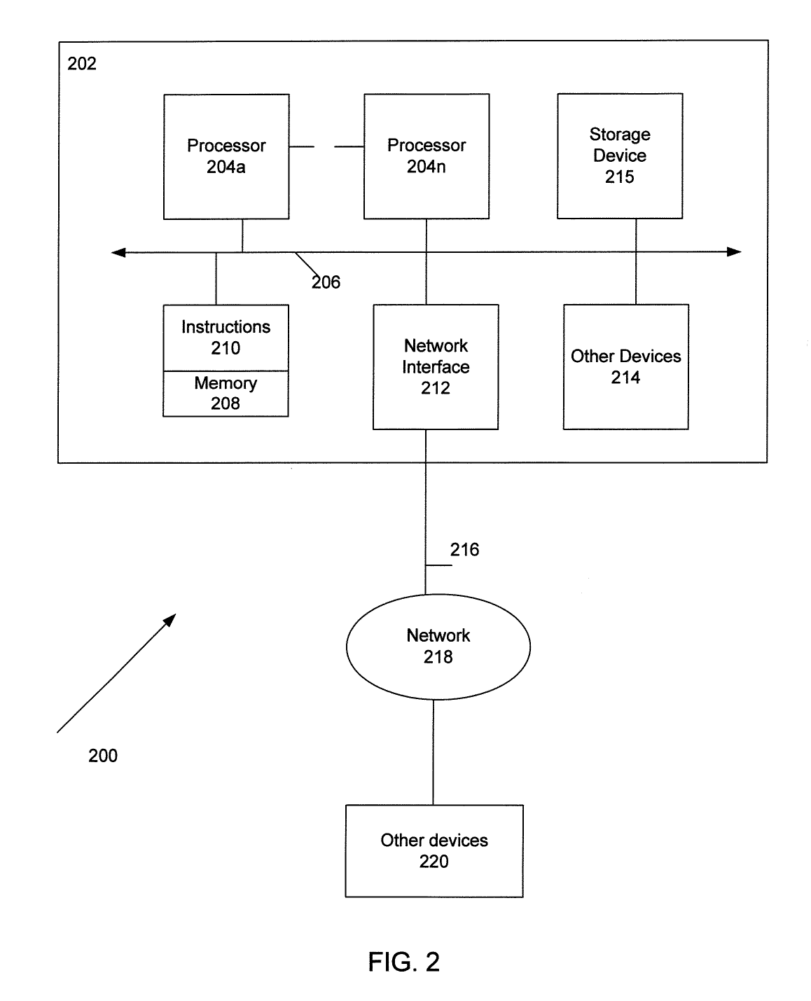

FIG. 2 is a high-level block diagram showing an example of a processing system 200 (or computing system 200) that can be used for executing programmable instructions described below. The processing system 200 may be used to execute programmable instructions for referral engine 102, vendor system 108, user system 122, social network system 108 and user friend's system 120 and 126, respectively. Note that certain standard and well-known components which are not germane to the present invention are not shown in FIG. 2.

The processing system 200 may include one or more processors 204a-204n (jointly and/or individually referred to as 204) and a memory 208, coupled to a bus system 206. The bus system 206 is an abstraction that represents any one or more separate physical buses and/or point-to-point connections, connected by appropriate bridges, adapters and/or controllers. The bus system 206, therefore, may include, for example, a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”).

The processors 204 are the central processing units (CPUs) of the processing system 200 and, thus, control its overall operation. In certain embodiments, the processors 204 accomplish this by executing executable instructions 210 stored in memory 208. A processor 204 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

Memory 208 represents any form of random access memory (RAM), read-only memory (ROM), flash memory, or the like, or a combination of such devices. Memory 208 includes the main memory of the processing system 200.

Programmable instructions 110 may include executable code for controller module 112, database 114 and communication module 116. Programmable instructions may also include executable code for vendor system 108 and referral engine interface 110. Furthermore, programmable instructions may also include instructions for interfacing with social network system 118. Programmable instructions 210 may be used to implement the processes described below and code for the various systems described with respect to FIG. 1.

Also connected to the processors 200 are one or more internal mass storage devices 215, and a network adapter/interface 212. Internal mass storage devices 215 may be or may include any conventional medium for storing large volumes of data in a non-volatile manner, such as one or more magnetic or optical based disks.

The network adapter 212 provides the processing system 200 with the ability to communicate with other devices or systems 220 over a network 218 via link 216. As an example, network 218 may be the Internet that is briefly described below.

The processing system 200 may also include one or more other devices 214 coupled to the bus system 206. The other devices 214 may include, for example, a display device, a keyboard, a mouse, etc.

Internet:

The Internet connects thousands of computers world wide through well-known protocols, for example, Transmission Control Protocol (TCP)/Internet Protocol (IP), into a vast network. Information on the Internet is stored world wide as computer files, mostly written in the Hypertext Mark Up Language (“HTML”). Other mark up languages, e.g., Extensible Markup Language (XML) may also be used. The collection of all such publicly available computer files is known as the World Wide Web (WWW). The WWW is a multimedia-enabled hypertext system used for navigating the Internet and is made up of hundreds of thousands of web pages with images and text and video files, which can be displayed on a display device. Each web page can have connections to other pages, which may be located on any computer connected to the Internet.

A typical Internet user uses a client program called a “Browser” to connect to the Internet. A user can connect to the Internet via a proprietary network or via an Internet Service Provider. The web browser may run on any computer connected to the Internet. Currently, various browsers are available including Firefox, Safari, Google Chrome and Microsoft Internet Explorer.

The Web Browser receives and sends requests to a web server and acquires information from the WWW. A web server is a program that, upon receipt of a request, sends the requested data to the requesting user.

A standard naming convention known as Uniform Resource Locator (“URL”) has been adopted to represent hypermedia links and links to network services. Most files or services can be represented with a URL.

URLs enable Web Browsers to go directly to any file held on any WWW server. Information from the WWW is accessed using well-known protocols, including the Hypertext Transport Protocol (“HTTP”), HTTPS (HTTP Secure, a secured protocol to provide encryption and secure identification of a server), the Wide Area Information Service (“WAIS”) and the File Transport Protocol (“FTP”), over TCP/IP protocol. The transfer format for standard WWW pages is Hypertext Transfer Protocol (HTTP).

Process Flow:

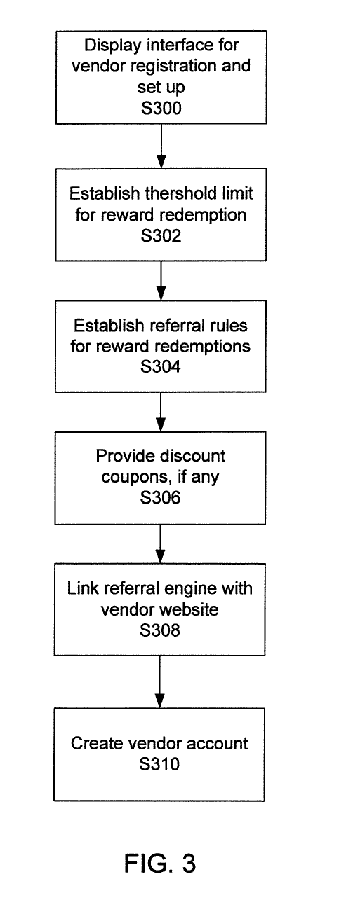

FIG. 3 shows a process flow diagram for registering a vendor with referral engine 102, according to one embodiment. The process begins in block S300, when an interface is displayed to a vendor. In one embodiment, the interface is displayed via interface 110 on a display device (not shown) used by vendor module 104. The display device may be a monitor, television or any other type of display device that can display digital information.

The interface is provided to the vendor to set up their account to use the referral engine and is used to collect vendor information to create a vendor account. The vendor enters information, for example, address, phone number, email address, website address, password and user name to access the account and any other information that can be used to setup the user account.

In block S302, the vendor establishes redemption rules before a user can redeem cash and/or rewards for referrals. For example, a vendor may establish a minimum value that a user has to accrue, before the user is permitted to redeem any cash.

In block S304, the vendor using vendor module 104 can establish referral rules for users. The nature and type of rules would depend on the product and services that the vendor may be offering. For example, if the vendor is a hotel, then the hotel may establish a rule that when a user refers a friend and the friend stays for a minimum of two nights and spends at least 200 dollars, then the user is entitled to get 2% of the amount spent. In one embodiment, the system is flexible, such that each vendor and vendor type may establish their own referral rules based on their business needs and markets.

In block S306, a vendor may provide incentive coupons, if any, to referral engine 102. The incentive coupons may be offered to the referred potential customers as well as to current customers that refer potential customers via referral engine 102. The vendor has the flexibility of defining what would be included in the incentive coupon and who should get the incentive coupon. For example, a hotel may offer a free room upgrade, free spa, complimentary meals and/or drinks, a shoe retailer may offer a free RFId chip with a shoe and others. These non-limiting examples are only provided to illustrate some of the incentives that the vendor can offer.

In block S308, referral engine 102 establishes a link with vendor system 108. This allows referral engine to track users and their referrals when they buy products and/or services on-line. Thereafter, in block S310, a vendor account is created. This allows the vendor to use Social Loyalty based on which, the vendor gets more business referrals from the user's network. The vendor pays a percentage to the user, a percentage to the entity that controls referral engine 102 and the rest kept by the vendor. It is noteworthy that the payment may also be a fixed fee, loyalty points, incentives or other reward types. The paid percentage is an example of the reward system and is not intended to limit the adaptive embodiments.

As described below in more detail, the vendor can also use the interface to view textual and graphic statistics for a total number of user's using the system, a total number of invited guests, a total amount of referral fee paid & total revenues generated by an invited guest.

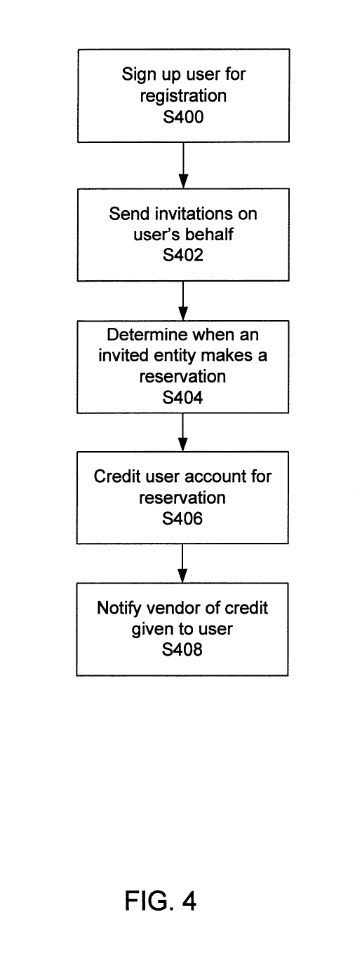

FIG. 4 shows a process flow diagram for interfacing with a user system, according to one embodiment. The process begins in block S400 when a user is signed up with the referral engine 102. This may occur in different ways, depending on the vendor's business practice. For example, if the vendor is a hotel, and when a guest is checking out, the vendor may ask the user to sign up with referral engine 102. The vendor may obtain user contact information (for example, user email, phone number, address or any other information) and provide it to referral engine 102 such that the referral engine 102 may contact the user to sign up for the referral system disclosed herein. In one embodiment, the user is contacted electronically to sign up for the referral system.

The sign up process includes creating a user password and account. Once the user account is created, the user is displayed a dashboard which provides the user with various options and information about the account. Dashboard examples are described below in detail.

In block S402, an invitation is sent to user's friends, on behalf of the user. The invitation may be sent directly (for example, via electronic mail, SMS, a printed mailer or any other means) to the friend or may be sent via a social networking system, for example, Facebook, Twitter and others. In one embodiment, referral engine 102 sends an electronic invitation on behalf of the user. In another embodiment, the vendor (for example, the hotel) sends the invitation on the user's behalf.

In block S404, when a referred friend buys a product or makes a reservation, referral engine 102 is notified. There are different ways to track when the referred friend buys a product, for example, by using cookies. A cookie(may also be referred to as a “tracking cookie”, “browser cookie” or “HTTPS cookie”) is a small piece of text stored on a user's computer by a web browser. A cookie consists of one or more name-value pairs containing bits of information. The cookie is typically sent as an HTTP header by a web server to a web browser and then sent back unchanged by the browser each time it accesses that server. A cookie can be used for authentication, session tracking (state maintenance), storing site preferences, shopping cart contents, the identifier for a server-based session, or anything else that can be accomplished through storing textual data. Another way to track user purchase is by using a tracking pixel, a well known technique used to track who if a user has read a web page or e-mail, if a web page was copied to another website and other functions.

It is noteworthy that the adaptive embodiments disclosed herein are not limited to any particular tracking mechanism.

In block S406, referral engine 102 gives credit to the user after the vendor has confirmed the sale of the product and/or service to the referral engine. The amount of credit would depend on the referral rules that are established by the vendor.

In block S408, the vendor is notified of the credit that is provided to the user.

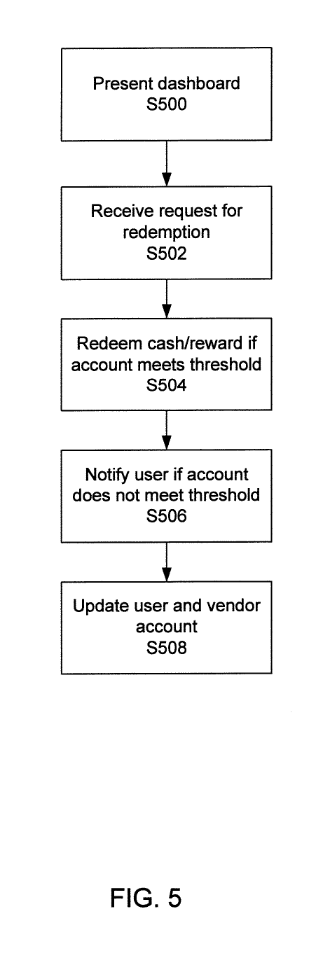

FIG. 5 shows a process flow diagram for interfacing with a user, according to one embodiment. The process starts in block S500, when a user is presented with a “dashboard” within user interface 124. The dashboard appears on a display device and is presented to the user by referral engine 102 executing programmable instructions. The dashboard includes information regarding user account, for example, amount of credit the user may have earned, the number of invitations sent on behalf of the user, number of responses received in response to the invitations and other related information.

In block S502, a user may send a request from user system 122 to referral engine 102 for redeeming any cash/reward that may have accrued in user account. The request is sent electronically through a user account.

In block S504, the user request for cash and/or rewards is executed, if the user meets the minimum threshold amount. The threshold amount is established by the vendor as described above. For example, a vendor may establish that a user can only redeem in increments of 100 dollars. In this example, a user must have at least 100 dollars to redeem. The embodiments herein are not limited to any particular minimum amount.

If the user does not meet the threshold amount, then the user is notified in block S506.

If redemption did occur in block S504, then the user account is updated in block S508. The vendor account is also updated so that the vendor knows when redemption takes place in block S504.

Screenshots:

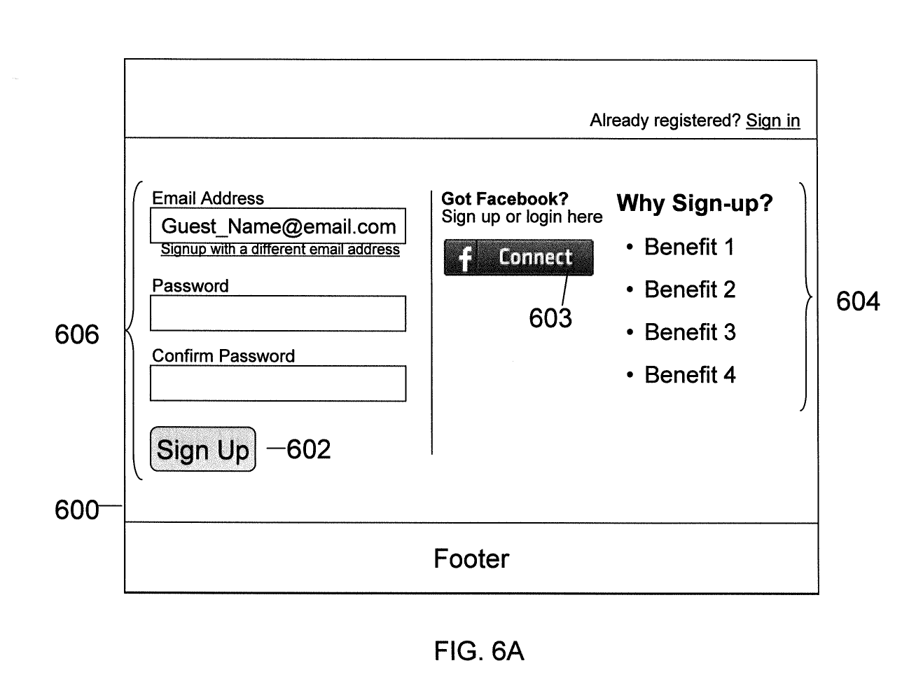

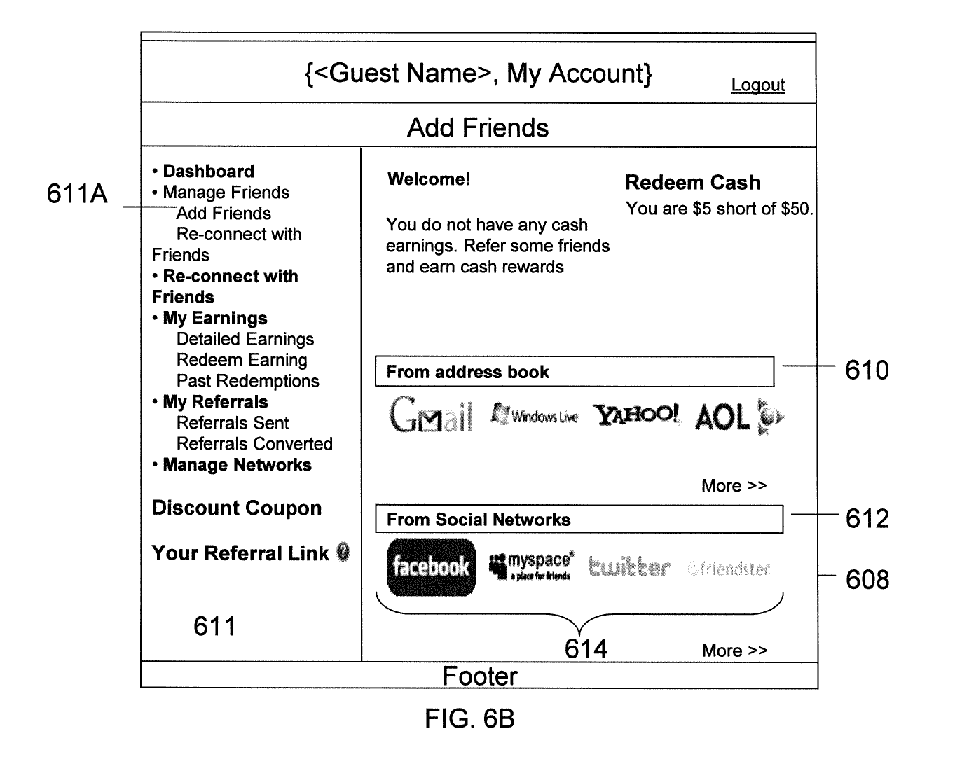

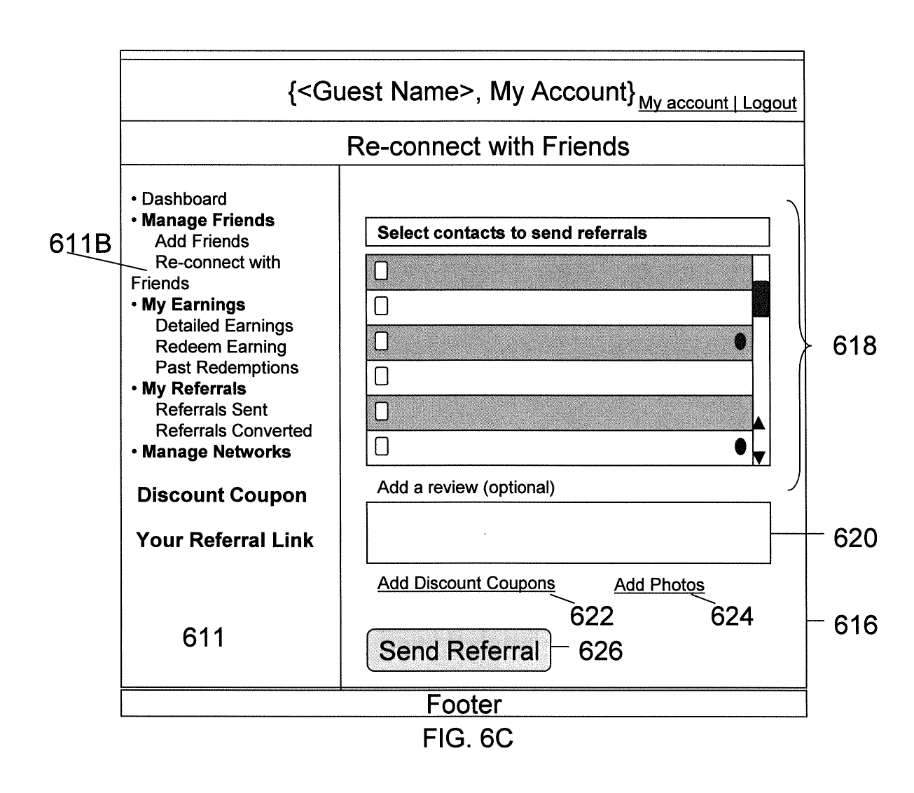

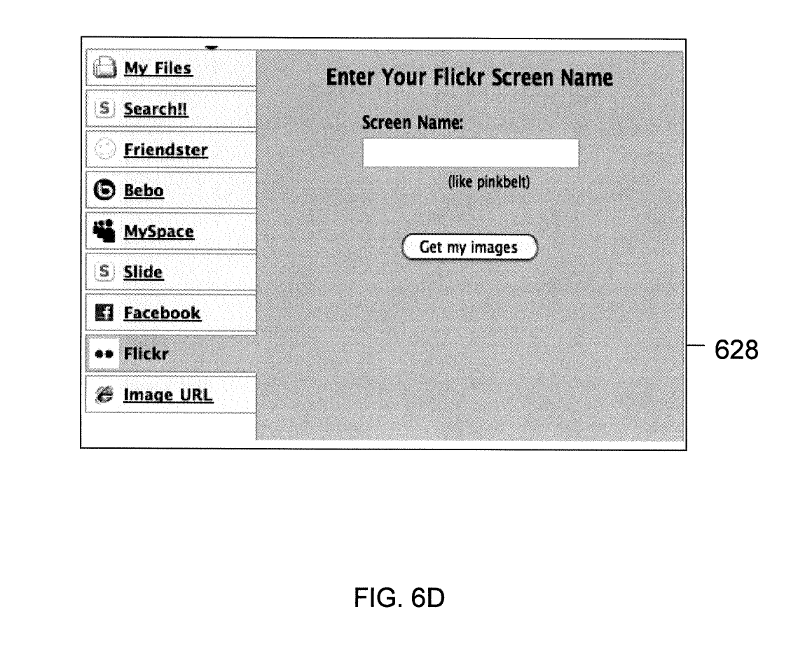

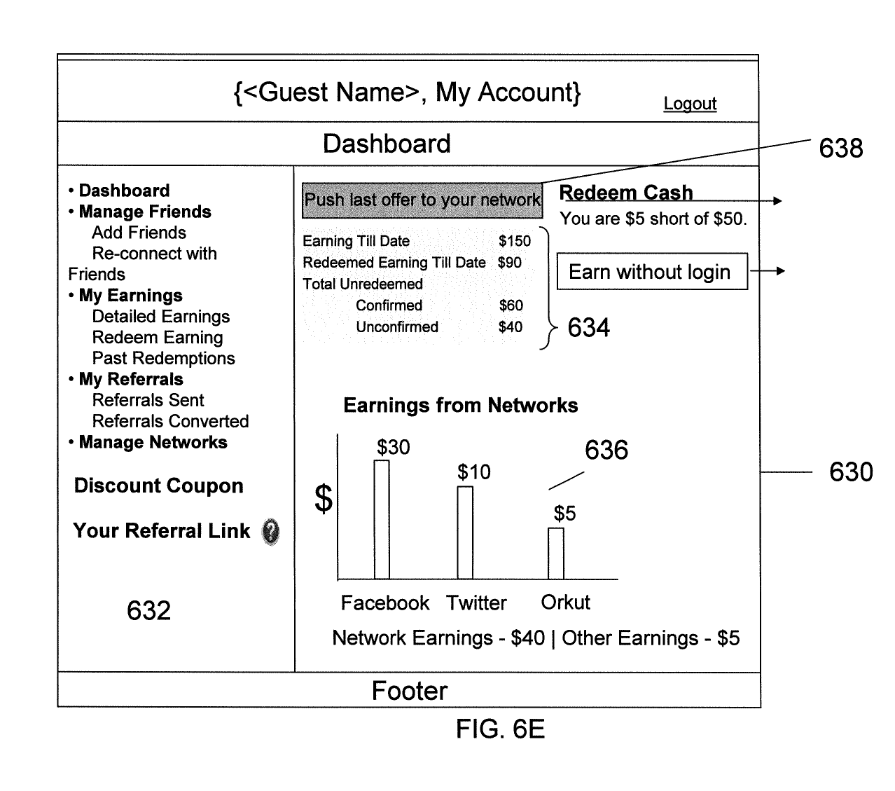

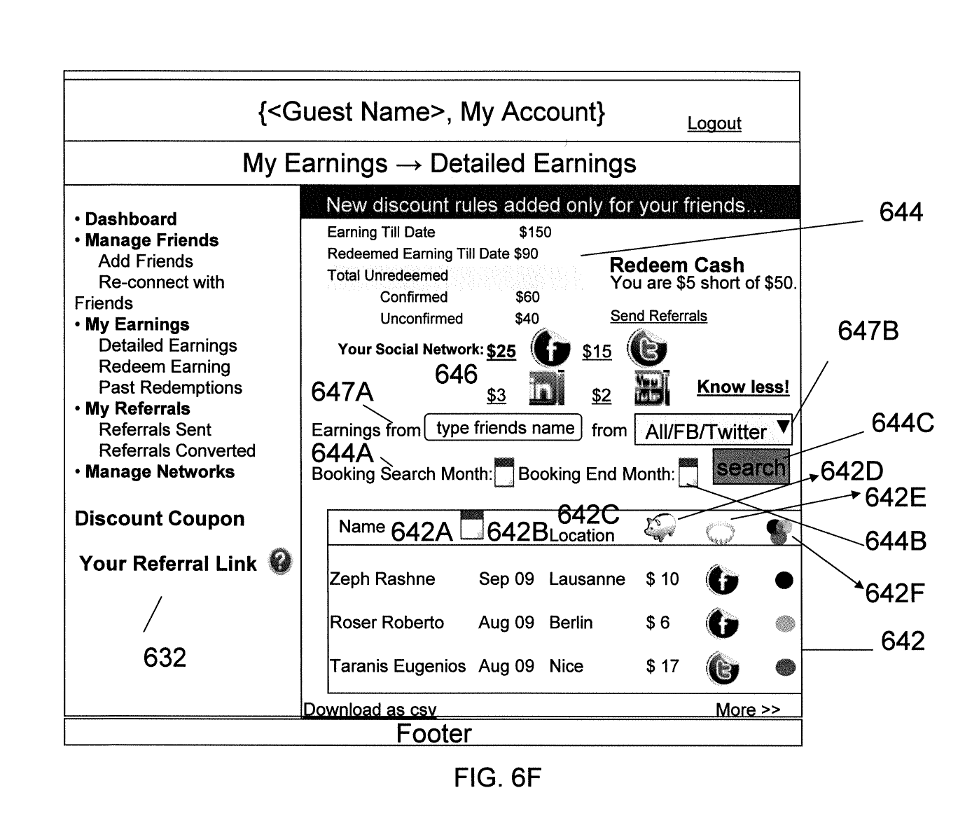

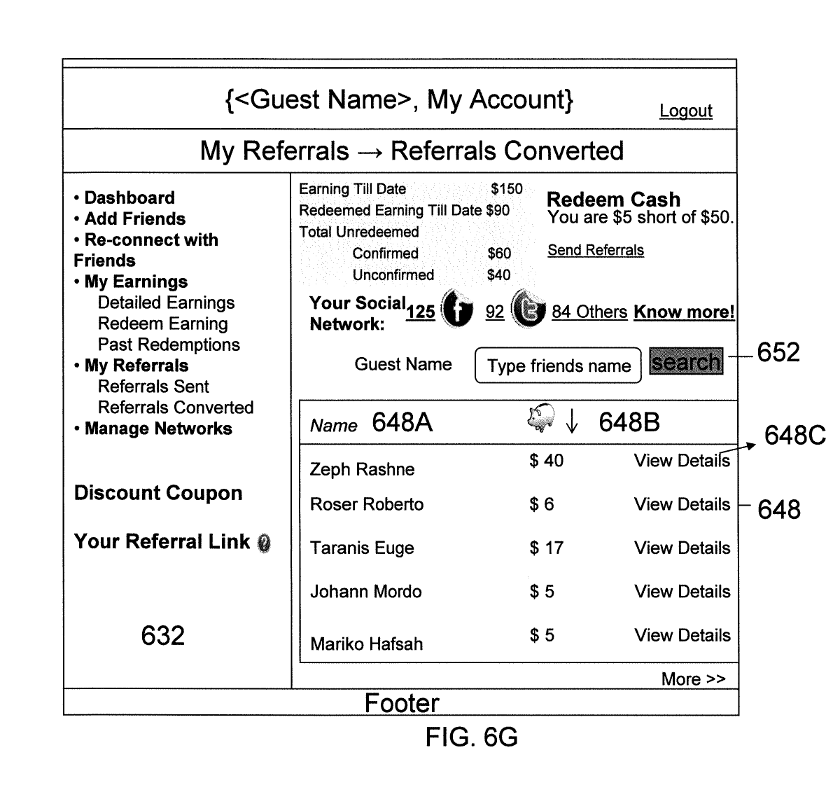

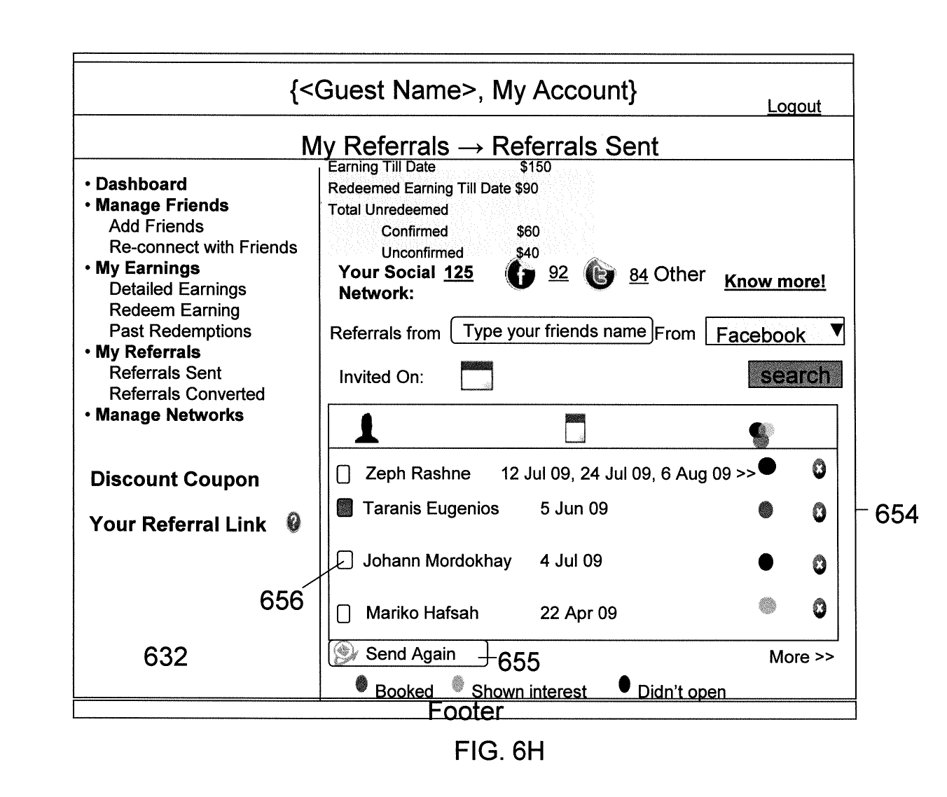

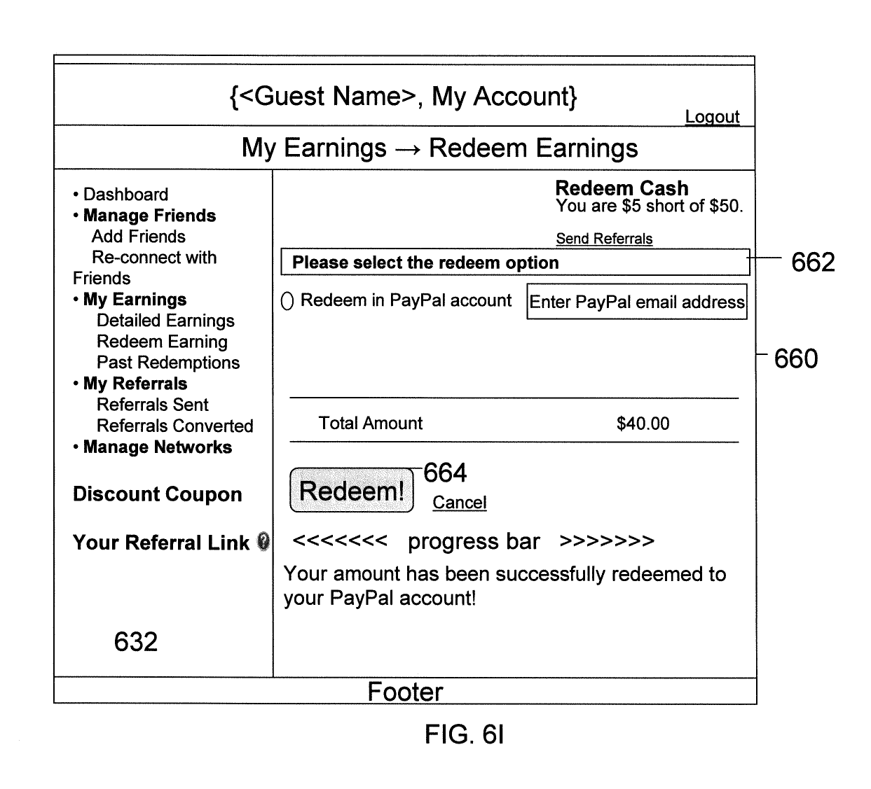

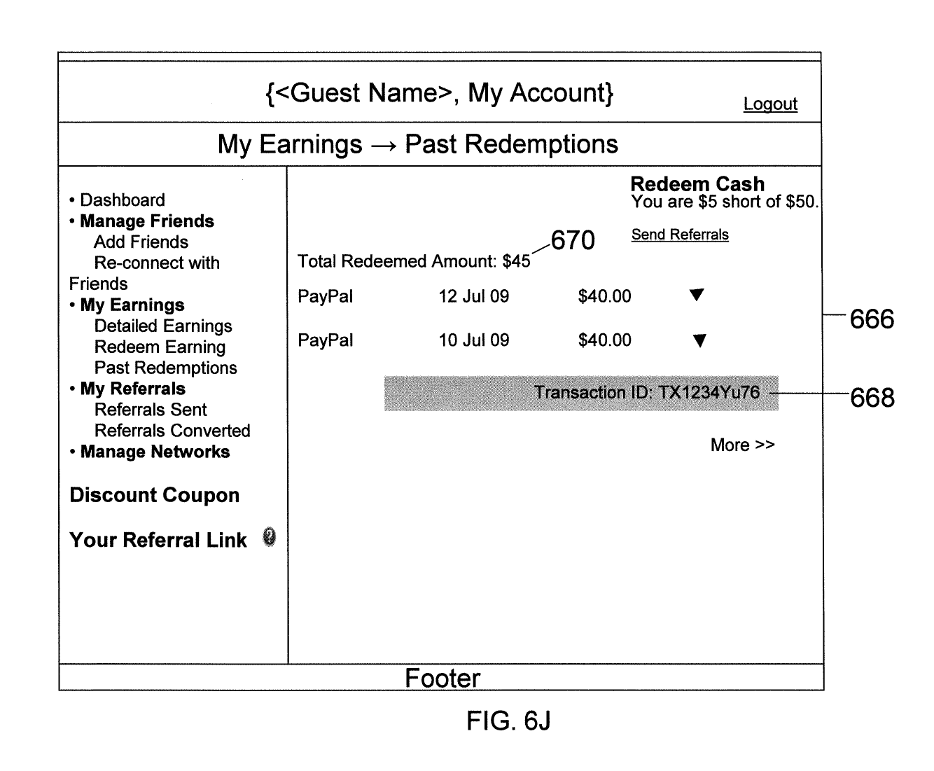

FIGS. 6A-6J, 7A-7K and 8 show examples of screen shots for using the various adaptive embodiments disclosed herein. The examples shown in the screenshots may include references to the travel/hotel industry but the embodiments and the screen shots are applicable to any industry that offers products and/or services and can use the “Social Loyalty” concepts disclosed throughout this specification.

FIGS. 6A-6J show examples of screen shots that are displayed at user interface 124 for implementing the process steps described above with respect to FIGS. 3-5, according to one embodiment. Throughout the specification and in particular with respect to the screen shots, referral engine 102 is referred to as Social Loyalty and hence the terms should be construed interchangeably.

FIG. 6A shows a sign up screen 600 as displayed to a user in block S400 of FIG. 4. Sign up screen 600 is provided by referral engine 102 based on executable instructions that are executed by a processor out of a memory.

Sign up screen 600 includes a segment 606 where a user provides an email address and password. By selecting selectable button 602, the user is signed up with referral engine 102. If a user wants to know the benefits of signing up, then screen 600 provides that information in segment 604.

Screen 600 also provides an option 603 that allows the user to sign up through a social networking system, for example, Facebook. In this example, “Facecbookconnect”, is a plug-in that allows an application to interface with the user's Facebook account may be used to interface with the user account on Facebook and with referral engine 102. More details regarding social networking system interaction are provided below.

FIG. 6B shows a screen 608 that is displayed on a display device to the user with different options that allow a user to invite friends. Screen 608 is provided by referral engine 102. Screen shot 610 includes segment 611 from where a user can perform various functions, for example, managing friends, review user earning, review referral information and others. Segment 610 may be accessed by selecting 611A (“Add Friends” option) and allows a user to send invitations to contacts from a user address book. The address books may be provided at a user system by an email system for example, Microsoft® Outlook (without derogation of any trademark rights of Microsoft Corp.) or a web-based system, for example, Gmail provided by Google Inc, without derogation of any trademark rights of Google Inc.) Yahoo mail provided by Yahoo Inc. (without derogation of any trademark rights of Yahoo Inc.) and others.

The user may also invite friends from a social network, for example, Facebook®, Myspace®®, Twitter®, Friendster and others (without derogation of any trademark rights). This option is provided in segment 612.

FIG. 6C shows a screen 616 provided by referral engine 102 on a display device that allows a user to add information and customize invitations via the “Reconnect with Friends” option 611A from segment 611. Selectable segment 618 allows the user to select a contact. A user may add a vendor product/service review in segment 620. For example, the user can review a hotel where the user stayed and add a review about user stay at the hotel. The user is also allowed to upload pictures via option 624 and add incentive coupons via option 622. The incentive coupons are sent by the vendor via the referral engine to the user which can then be sent to the users' friends. Segment 626 may be used to electronically send the referral to contacts specified in segment 618.

FIG. 6D shows a screenshot 628 from where a user can add pictures. This example shows that one can add pictures using the website “flickr.com” (without derogation of any trademark rights).

FIG. 6E shows a user dashboard 630 provided by referral engine 102 with account information and a plurality of options. Segment 632 (similar to 611, mentioned above) provides different selectable options, from where a user can manage friends, review earnings, review referrals and manage networks. Segment 634 provides a snapshot of the total earnings, amount unredeemed and the amount redeemed. Segment 636 shows the total earnings from various networks, for example, $30.00 from Facebook, $10.00 from Twitter and $5.00 dollars from Orkut (without derogation of any trademark rights). This information is obtained from database 114.

Option 638 provides the user with an option to push or send a previous offer with incentives to his or her social network.

FIG. 6F shows a screen 642 provided by referral engine 102 that displays a report to the user with a breakdown of earnings based on the activity of the referred friends. The report may be accessed from segment 632 by selecting the option “Detailed Earnings”. Segment 644 shows that the total earnings. Segment 646 of screen 642 provides a breakdown of what was earned via the social network including which network earned the most (for example, Facebook earned $25.00).

A user can search for data using options 644A and 644B. Options 644A and 644B allow the user to specify a time frame and option 644C executes a search. The user may also specify a friend's name in block 647A and specify the name of a network in block 647B. The search is based on data stored in database 114 by controller module 112. Referral engine 102 searches database 114 and displays data in columns 642A-642G.

Column 642A displays the names of the friends that bought a product or service through the referral, for example, made a reservation. As an example for the hotel industry, Column 642B shows the date the stay started. In another industry, these columns may include product/service details that would depend on the industry type. For example, for a car rental industry Column 642B may show the data of the car rental. Column 642C shows the hotel location, while column 642D shows the amount that the user earned because of the stay. Column 642E shows which social network was used for a particular person. Column 624F shows a status of the amount that was earned by the user, for example, a green dot may indicate that the amount has been redeemed and a red dot may mean that it has not yet been redeemed.

FIG. 6G shows a screen shot 648 that is presented when the user selects the “Referral Converted” option from segment 632. A search box 652 is also provided to the user, to search for information based on a friend's name, earnings, referrals, invites within a certain date range (for example, July 14-August 14). The user may select a date range and controller 112 of referral engine 102 searches database 114 for information. The search results are displayed within screen shot 648.

As an example, information is displayed in different columns. For example, column 648A lists the names of the referrals, while column 648B shows the amount earned. The user can view details by selecting option 648C that would take the user to the screen shown in FIG. 6F. Screenshot 648 provides a summary of referrals compared to the screenshot 642 shown in FIG. 6F.

FIG. 6H shows a screen shot 654 when the user wants to review the invites that are sent within duration. Screen shot 654 may be accessed from segment 632. Screen shot 654 shows the status of each invitation (for example, 656 for Johann Mordokhay), i.e. bought, shown interest and “didn't open”. Based on the status of each invitation, the user may take an appropriate action. For example, if the invitation was not opened (656) then the user may want to resend the invitation by using the invite again option 655.

FIG. 6I shows a screenshot 660 from where a user can redeem cash/points that may have been earned using the referral engine 102, disclosed according to one embodiment. For example, segment 662 provides selectable options to either redeem cash to a Paypal® (without derogation of any trademark rights) account, get an “iTunes coupon” (not shown) or an “Amazon” coupon (not shown). After selecting one of the options, user may redeem by clicking on button 664. Once the user uses button 664, a screen 666 is presented in FIG. 6J.

Screen 666 shows that an amount of $45.00 was redeemed and transferred to user Paypal account. The amount is shown in segment 670 and the highlighted portion 668 provides a transaction identifier for the transfer of funds.

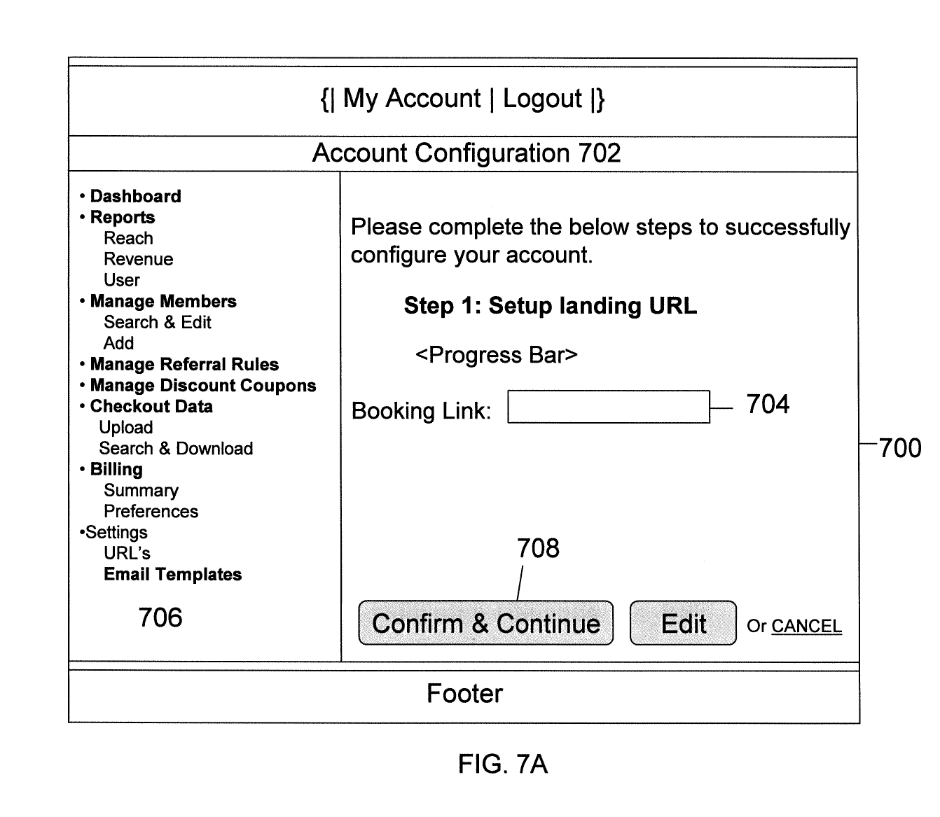

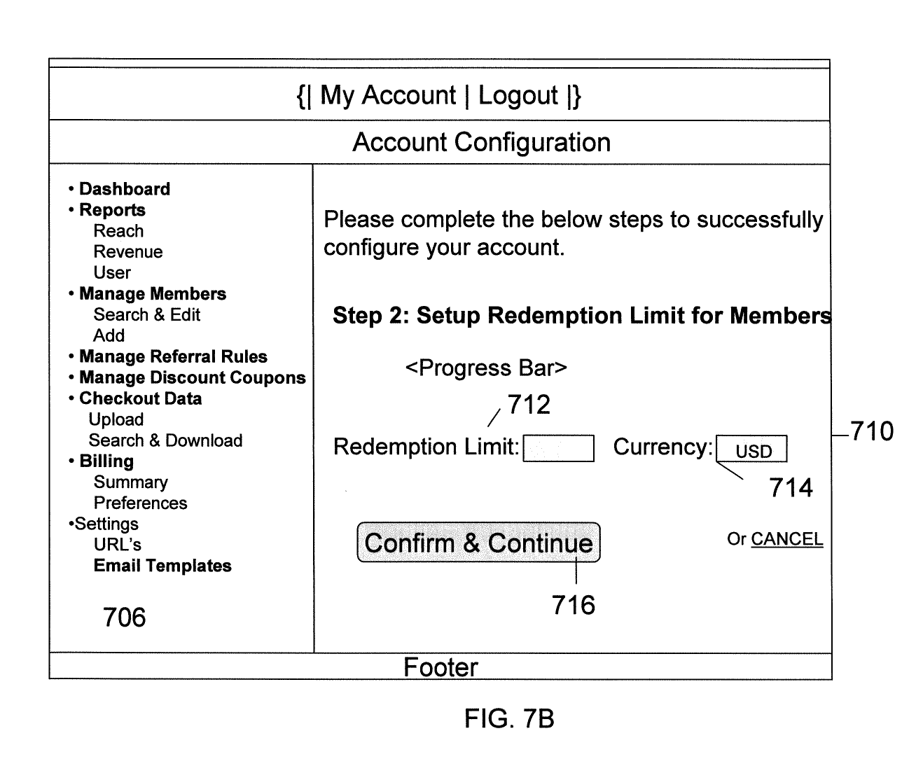

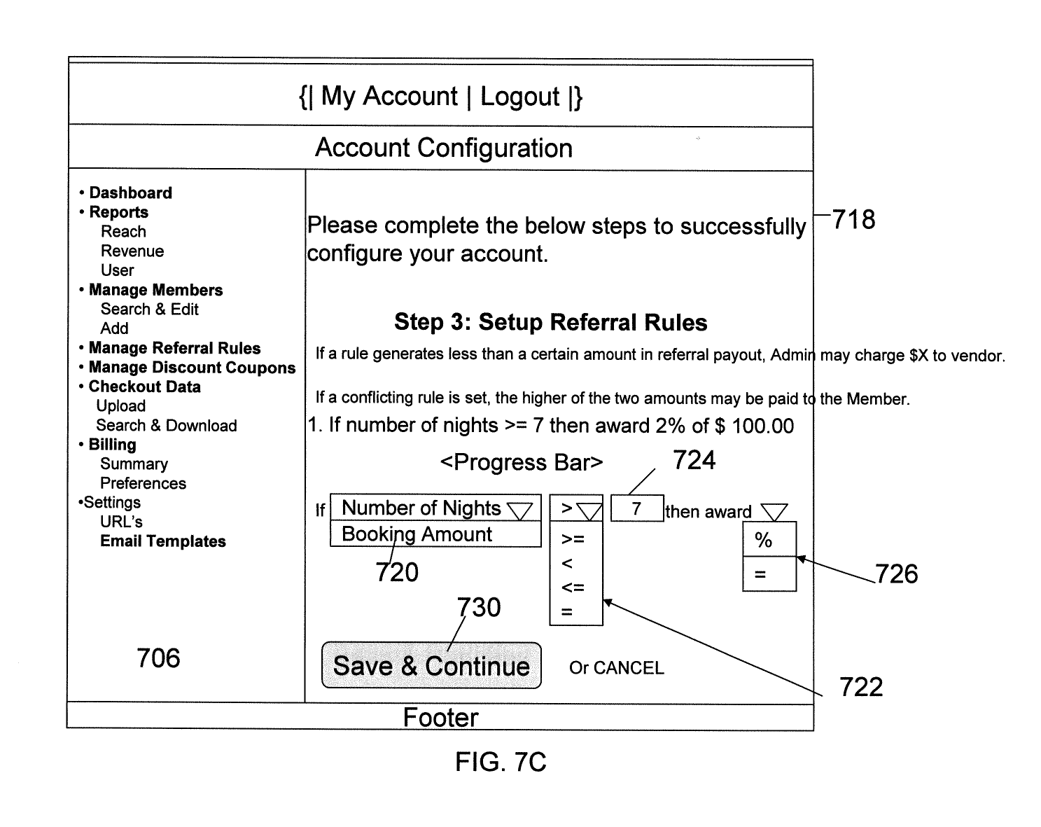

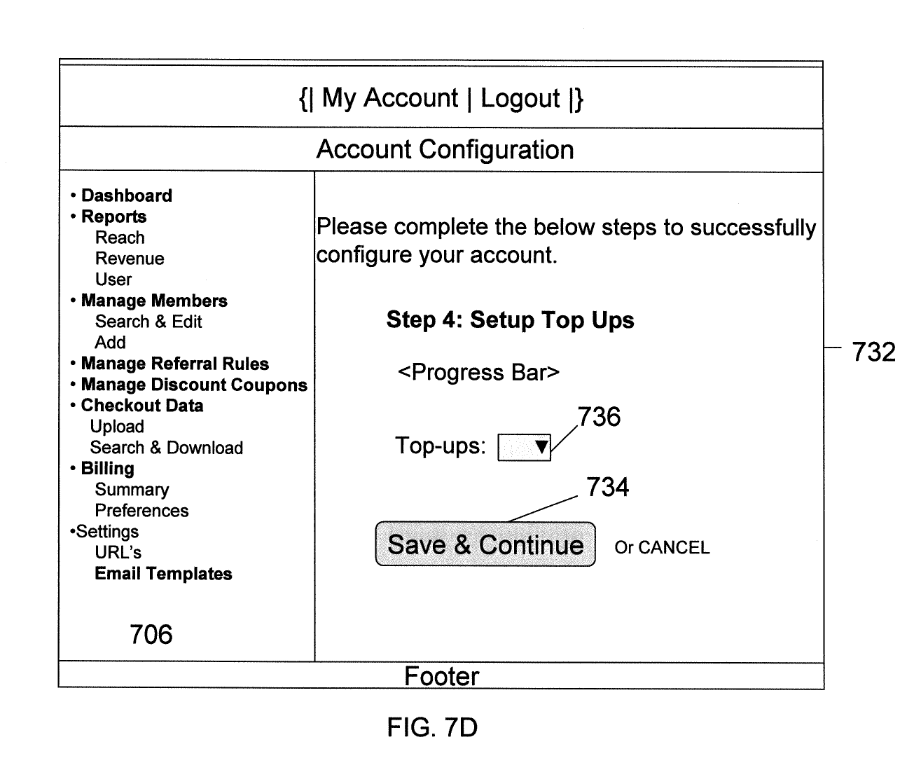

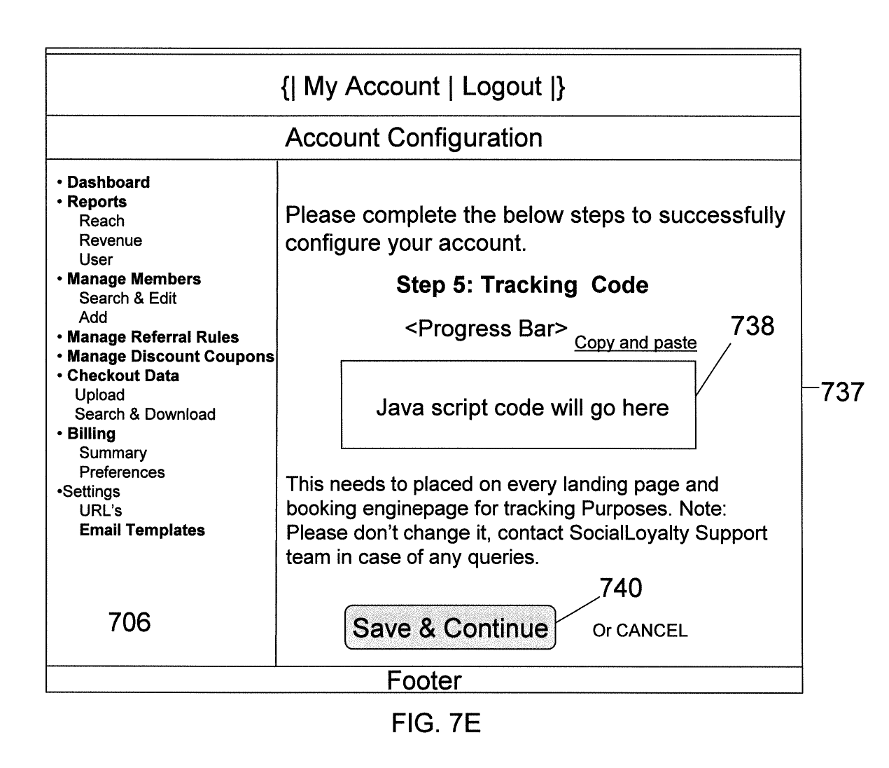

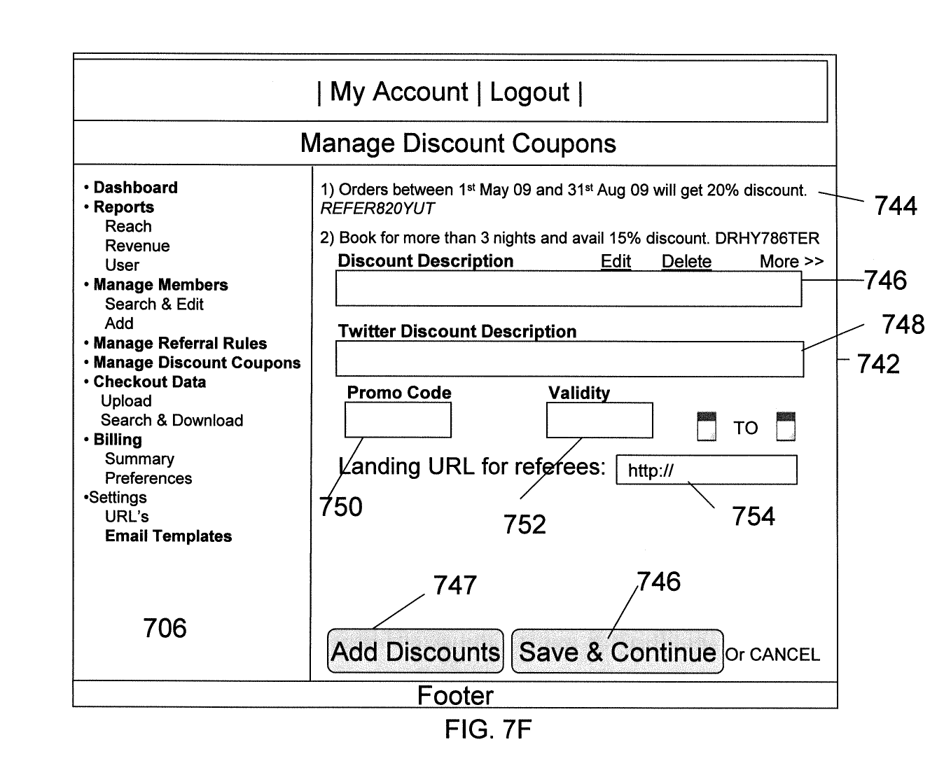

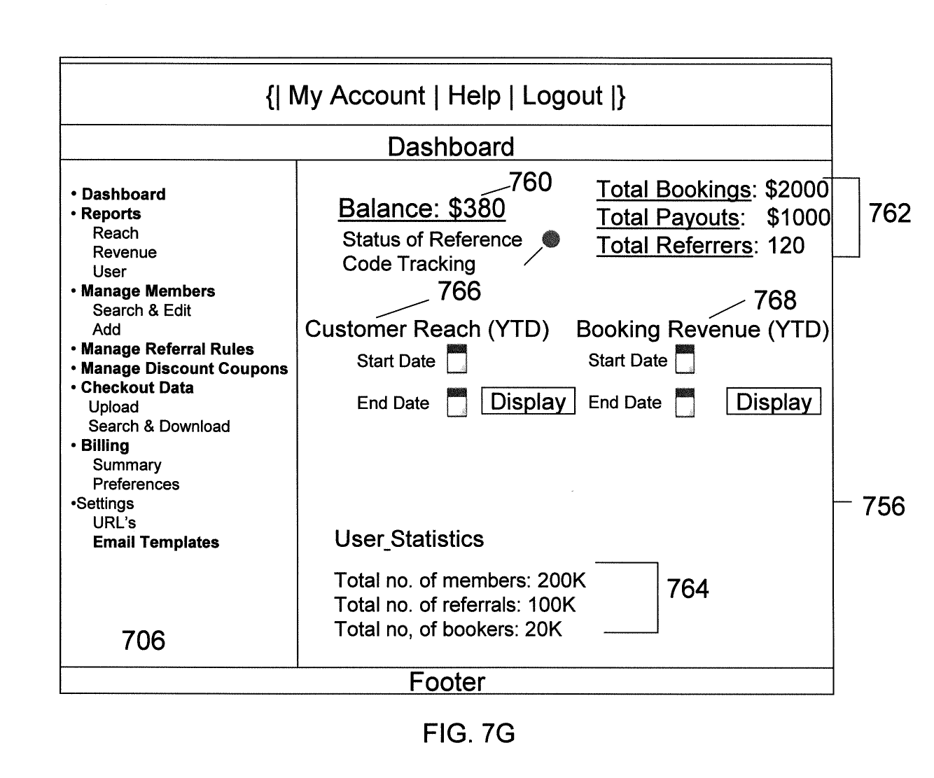

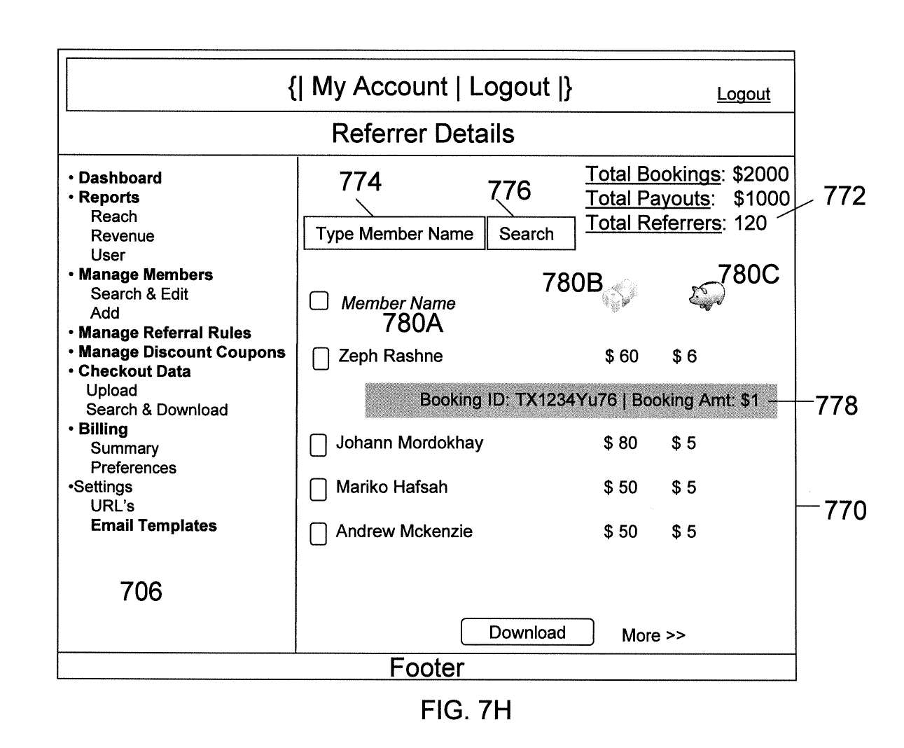

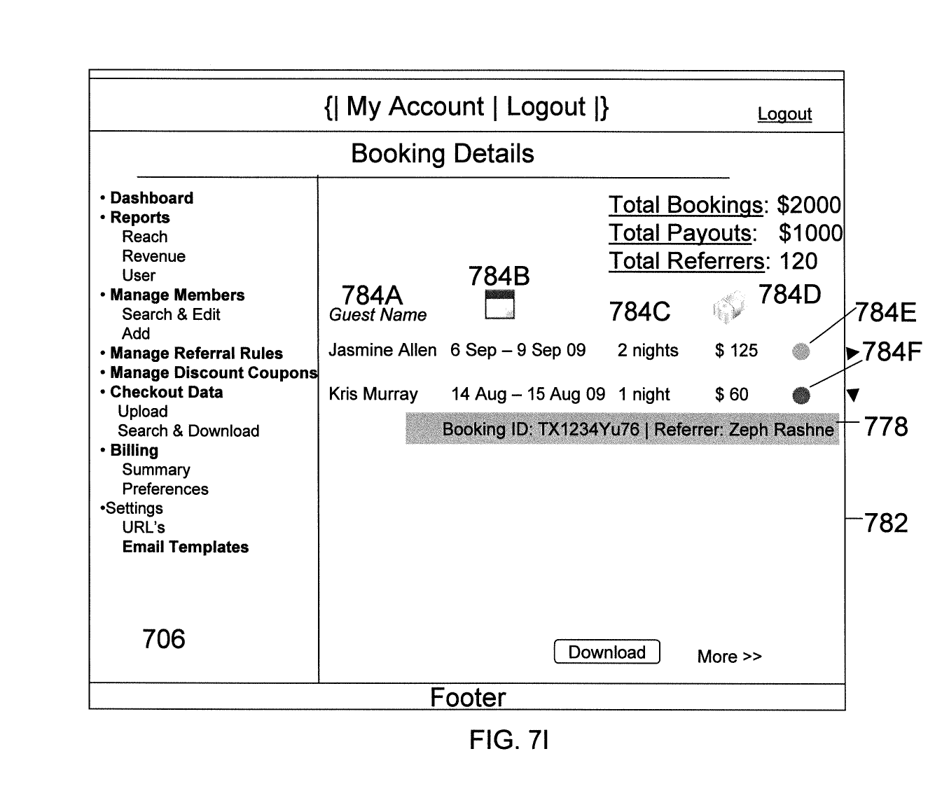

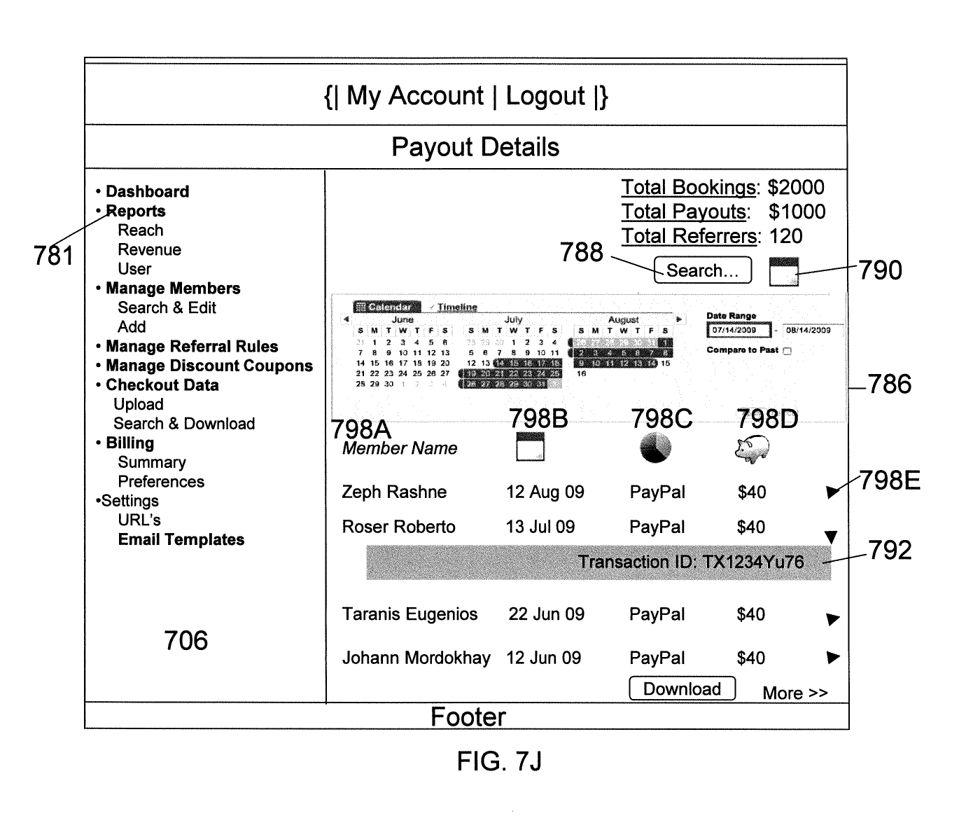

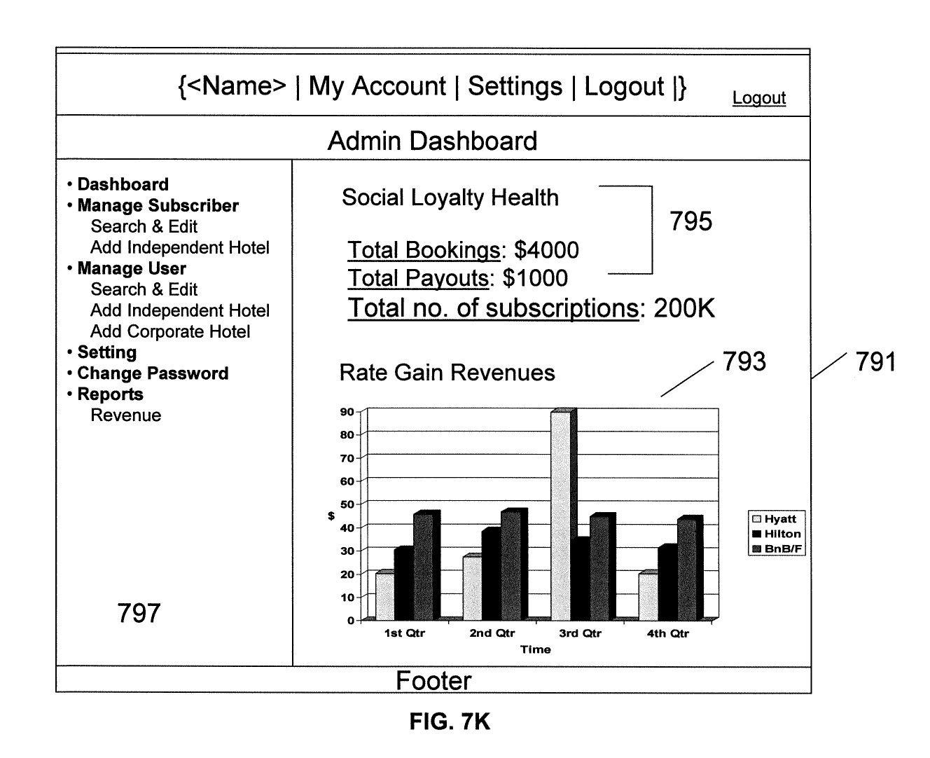

FIGS. 7A-7K show different screen shots that are presented by referral engine 102 and displayed at a display device for a vendor (for example, a hotel). These screen shots show different interactions between a vendor and referral engine 102, according to one embodiment. In some of these screen shots a hotel may be referenced as an example only and not to limit the adaptive embodiments.

FIG. 7A shows a vendor screenshot 700 with segment 706 providing various selectable options, labeled as Dashboard, reports, Manage Members, manage Referral Rules, Manage Discount (or incentive) Coupons, Checkout Data and Billing. Screen 700 is displayed on a display device by the referral engine 102 based on executable programmable instructions that are executed by a processor.

Screen 700 provides the vendor with an option 702 to configure or set up a vendor account. The set up process allows a vendor to enter a “booking link” at segment 704. The vendor confirms the URL by selecting option 706 and continues to FIG. 7B.

In FIG. 7B, the vendor uses screen 710 to enter a redemption limit in segment 712. The redemption limit is a threshold value based on which a user can redeem earned rewards. The limit may be specified as a dollar value in block 714. After setting up the redemption values, the user confirms and continues by selecting option 716.

FIG. 7C shows a screen shot 718 for setting up referral rules. The referral rules are set up in segment 720. The example of FIG. 7C is for a travel or hotel industry. For example, the referral rule may be based on the number of nights a guest stays at a hotel. Drop down menus 722, 724 and 726 are provided to input the rule values. The vendor confirms the rules by selecting option 730 and continues. The rules are saved in database 114 by controller 112. The rules are then used to distribute cash/rewards based on a user redemption request that was described above.

FIG. 7D shows a screen shot where Screenshot 732 that allows a vendor to indicate a “top up” amount using the drop down menu 736. The top up amount is a minimum balance that the vendor has to maintain from which a user is paid. The vendor can save the amount by selecting option 734 and move to FIG. 7E.

FIG. 7E presents a screen 737 where the vendor can place a tracking code (may also be referred to as “reference code”) within segment 738. The reference code is used to track purchases that are made using the referral engine 102 or via referral engine 102. The code is used in conjunction with a landing URL, for example, the landing URL shown in FIG. 7A.

FIG. 7F shows a screen shot 742 for managing incentives or discounts. Screen shot 742 may be displayed when a user selects the “Manage Discount Option” from segment 706.

Segment 744 of screen shot 742 shows an example of discount coupons that a vendor may provide. The coupon may be described in segment 746. A Twitter® description or a description using a limited number of alphabets is provided in segment 748. A promotion code is defined in segment 750. The vendor may indicate the validity of the coupon in segment 752. The landing URL for the coupon is specified in segment 754. The settings are saved by the vendor by selecting option 746. The coupons are saved by referral engine 102 when the vendor uses button 746. The vendor may add more coupons by selecting option 747.

Once a vendor is setup and registered with referral engine 102 (also referred to as “Social Loyalty” in the various screen shots), an authorized representative of a vendor may view a vendor dashboard within a screen shot 756 of FIG. 7G that is displayed on a display device at vendor module 104. The dashboard is displayed by referral engine 102 based on programmable instructions.

Segment 706 of screenshot 756 provides selectable options from where a vendor can access reports, manage members, manage referral rules, manage incentive/discount coupons, check data, review billing information and establish settings. Screenshot 756 provides a balance amount as $380 in section 760. The balance amount is maintained by referral engine 102 and is based on payments made by vendor to a member less any transaction fee charged by referral engine 102.

Segment 762 provides total “bookings”, which can mean total purchase; “total payout” i.e. the total amount paid to the referrers; and “total referrers” i.e. the total number of referrers.

Segment 764 provides user statistics. This includes the total number of members, referrals and bookers (i.e. buyers).

Segment 766 shows the “customer reach” and segment 768 shows the booking revenue. The customer reach defines a vendor's reach in a market. This number depends on a number of users plus user contacts/friends. For example, if a vendor has 500 users and each user has 100 contacts, then the vendor's reach is 50,000. The term booking revenue as used herein means the revenue generated by a vendor using referral engine 102. The commissions paid out to members are derived from the booking revenue.

FIG. 7H shows a screen shot 770 with referral details that are presented to a vendor by referral engine 102. Segment 772 provides a summary of total bookings, total payouts and total number of referrers.

A search option 750 is provided that allows one to search for members by using segments 772 and 774. The vendor can provide search parameters and the referral engine 102 gathers the information and displays it as a list.

The search results are displayed within screen shot 770 showing referrer names (shown as “member name” column 780A), amount paid for a purchase based on the referral (Column 780B) and amount paid out (Column 780C).

The vendor can select a member and view and transaction involving the member. The transaction is shown as 778 in FIG. 7H. By drilling down, the vendor can see more details regarding the transaction. This is shown in the screen shot 782 of FIG. 7I.

The details in screen shot may be presented as a plurality of columns 784A-784F with a plurality of entries. The example in FIG. 7I is for a hotel reservation, but is equally applicable to other products and services. For example, column 784A includes the name of the person who made the reservation; column 784B provides the dates when the guest stayed, column 784C lists the number of nights stayed, column 784D shows the total amount for the reservation.

Each entry also includes indicators under column 784E to show if a guest has checked out or not. For example, indicator 784F may be a yellow dot that indicates that a hotel guest has not yet checked out. A second indicator 784F may be a green dot that indicates that the guest has checked out.

An authorized person on behalf of the hotel can view details of an entry, after the entry is selected. For example, by selecting entry 778 one can see that Kris Murray booked between August 14-August 15 for 1 night at a rate of $60.00. A transaction identifier (shown as Booking ID in segment 778) is used to identify the transaction and the referrer is shown to be Zeph Rashne.

FIG. 7J provides a screen shot 786 with payout with to one or more referrers. Screen shot 786 is displayed by referral engine 102 based on information that is stored in database 114. Screen shot 786 includes a search option 788. Segment 790 provides an option that displays a calendar. The vendor can select the dates using the displayed calendar, as shown in FIG. 7J. The vendor may input a date range (for example, Jul. 14, 2009 to Aug. 14, 2009) or any other parameters to see the payout details. Referral engine 102 searches database 114 and then displays data within screen shot 786.

The displayed data includes column 798A showing the names of the referrers, column 798B that includes the date an amount was paid, column 798C that shows the method of payment (for example, Paypal), column 798D that shows the amount paid and column 798E that shows an arrow, which when selected provides transaction details for the redemption. An example of a transaction is shown in segment 792, where $30.00 were paid to Roser Roberto and the transaction ID (identifier) was TX1234Yu76.

In one embodiment, referral engine 102 also provides a reporting module to a vendor. The reporting module provides the vendor with a report on referrers, invitees, referrers and invitees, reservation or booked amount, amount that may have accrued due to the referral system and payout amount. The data for the reports is obtained by referral engine 102 from database 114.

An example of the reporting module is shown as 781 in screen shot 782 that allows a vendor to select a report from segment 706. The vendor may specify a date range and then either view the results on a display device or download the report in any format, for example, as an Excel file (xls). In one embodiment, the report is generated by a computing device executing programmable instructions (for example, code for controller module 112) to search and display the search results.

In one embodiment, as described above, an administrator (101, FIG. 1) using a computing system is able to manage referral engine 102. The administrator is displayed a dashboard on a display device by a processor executing programmable instructions. An example of a dashboard for managing vendors, for example, hotels, is shown in screen shot 791. Screen shot 791 includes a segment 797 from where an administrator can select various options, to manage different vendors (or subscribers), manage users by searching information regarding the vendors, adding new vendors and be able to generate reports.

Screenshot 791 shows a segment 795 from where the administrator can get a snapshot of the overall referral engine. Segment 795 shows the number of bookings, total amount of payouts and total number of subscriptions from different vendors.

Screenshot 791 may also include a graphical representation 793 of different vendor and the amount of revenue that is obtained from the different vendors.

Similar to other screen shots described above, administrator 101 (FIG. 1) can search for information by by specifying a data range. Search results can be displayed with the names of individual vendor, amount that is paid to an entity that is managing referral engine 102 and the amount that has been redeemed and paid to the referrers.

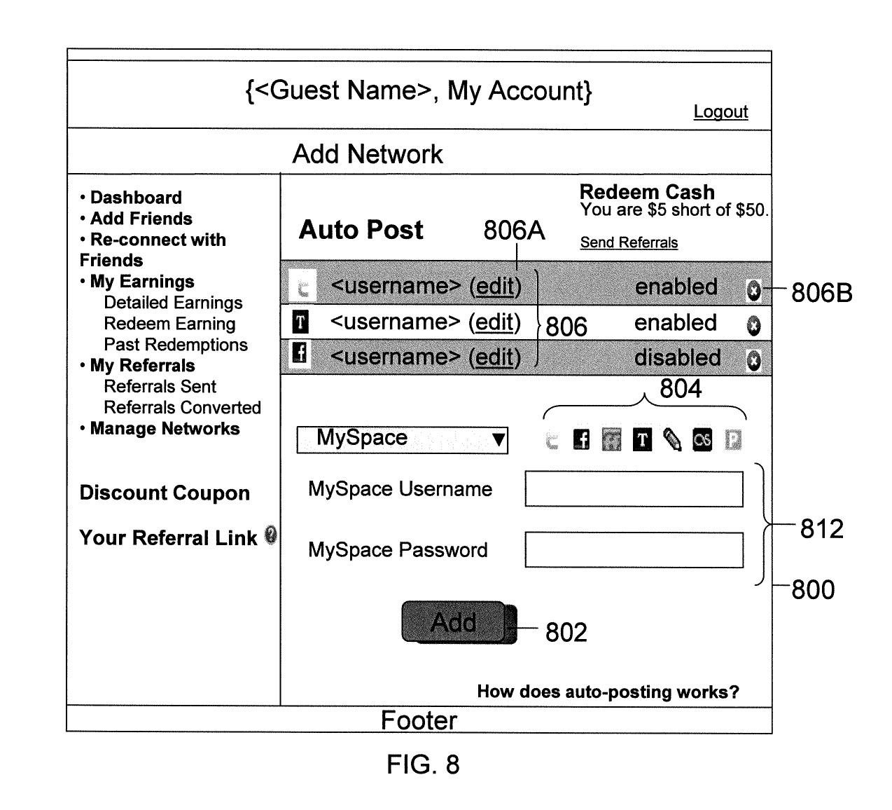

In one embodiment, as described above, referral engine 102 is able to leverage existing social networking for bringing consumer traffic to a vendor's website or a third party website that provides and products for the vendor. FIG. 8 show examples of interactions with various social networking sites, according to one embodiment.

FIG. 8 shows an example of a dashboard 800 that is displayed at user interface 124 by referral engine 102. Dashboard 800 allows a user to automatically post (i.e. connect) to a social networking site every time a user gets a “reward”. Segment 804 shows the different types of social networking websites that are supported by referral engine 102, for example, Facebook, Twitter, Tumbler, Blogger, Wordpress and others. The adaptive embodiments are not limited to any particular social networking website. Option 802 is provided such that a user can add a social networking site to the user account.

Segment 806 shows the different social networking websites (for example, Facebook, Twitter) that may already be associated with a user account. Option 806A allows a user to edit the account and option 806B removes the association with the social networking site.

Option 802 allows a user to add or “auto-post” a networking website. One is also able to log on to a networking website using options 812 for “Myspace” a social networking website. Of course, the embodiments herein are not limited to any particular website.

Referring back to FIG. 6A, option 603 in screenshot 600 allows a user to connect with user Facebook account using “Faceconnect”. Once a user is connected to Facebook, referral engine 102 can send updates about the hotels to user's account. The user may also post updates on the Facebook account.

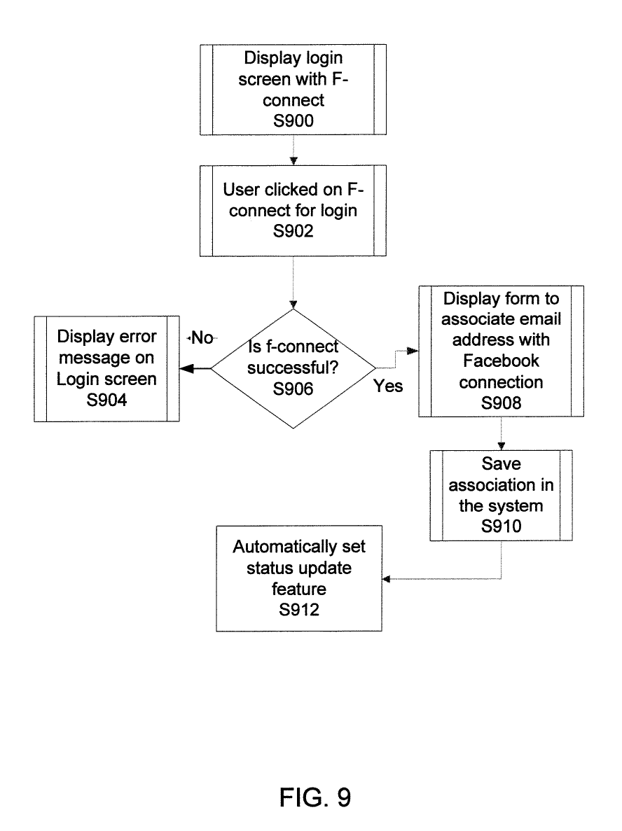

FIG. 9 shows a process flow diagram for using the “Facebookconnect” (shown as F-connect) option with referral engine 102. The process starts in block S900 when a login screen with the F-connect option is displayed, for example, 603 (FIG. 6A). The user clicks on the F-connect option in block S902.

In block S906, the system determines if the f-connect was successful. If yes, then in block S908, a form is displayed to associate an email address with the Facebook connection. The information is saved in database 114 (FIG. 1) in block S910 and an automatic status update feature is set in block S912. If the f-connect was unsuccessful in block S906, then an error is displayed in block S904.

Although the process flow of FIG. 9 is described with respect to Facebook, the adaptive embodiments are not limited to Facebook or any particular social network program. Any networking system may be able to use the FIG. 9 process flow diagram.

Thus, a social networking referral system has been described. Note that references throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics being referred to may be combined as suitable in one or more embodiments of the invention, as will be recognized by those of ordinary skill in the art.

While the present disclosure is described above with respect to what is currently considered its preferred embodiments, it is to be understood that the disclosure is not limited to that described above. To the contrary, the disclosure is intended to cover various modifications and equivalent arrangements within the spirit and scope of the appended claims.

What is claimed is:

1. A machine implemented method for a referral system, comprising:
(a) creating a vendor account for linking a vendor system with the referral system, the vendor system used for offering a vendor product and service;
(b) establishing a referral rule based on which a user earns an amount from using the referral system;
(c) establishing a threshold value based on which a user is permitted to redeem the amount earned by using the referral system;
(d) creating a user account with the referral system that allows the user to electronically refer another entity to buy the vendor product and service;
(e) sending an invitation to the another entity on behalf of the user, wherein the referral system sends the invite on the user's behalf with a review of the user's experience with vendor product and service;
(f) based on the referral, crediting the user account, when the other entity makes a purchase of a product, service or both; and
(g) redeeming the credited amount if the amount meets the threshold value set by the vendor.

2. The method of claim 1, wherein the other entity is a user friend that is invited via a social networking website.

3. The method of claim 1, wherein the vendor is a business entity.

4. The method of claim 3, wherein the user posts a product, service or a combination thereof review on a social networking site that is accessible to a plurality of user friends and based on the review a user friend makes a purchase.

5. The method of claim 3, wherein the vendor maintains a minimum account balance to use the referral system.

6. The method of claim 1, wherein the referral system displays a user dashboard such that the user can see an amount the user earned based on invitations sent on the user's behalf.

7. A machine readable storage medium storing executable instructions, which when executed by a machine, causes the machine to execute a method for a referral system, the method comprising:
creating a vendor account for linking a vendor system with the referral system, the vendor system used for offering a vendor product and service;
establishing a referral rule based on which a user earns an amount from using the referral system;
establishing a threshold value based on which a user is permitted to redeem the amount earned by using the referral system;
creating a user account with the referral system that allows the user to electronically refer another entity to buy the vendor product and service;
sending an invitation to the another entity on behalf of the user, wherein the referral system sends the invite on the user's behalf with a review of the user's experience with vendor product and service;
based on the referral, crediting the user account, when the other entity makes a purchase of a product, service or both; and
redeeming the credited amount if the amount meets the threshold value set by the vendor.

8. The storage medium of claim 7, wherein the other entity is a user friend that is invited via a social network.

9. The storage medium of claim 7, wherein the vendor is a business entity.

10. The storage medium of claim 9, wherein the user posts a product, service or a combination thereof, review on a social networking site that is accessible to a plurality of user friends and based on the review a user friend makes a purchase.

11. The storage medium of claim 9, wherein the vendor maintains a minimum account balance to use the referral system.

12. The storage medium of claim 7, wherein the referral system displays a user dashboard such that the user can see an amount the user earned based on invitations sent on the user's behalf.

13. A computer program product, comprising:
a computer usable storage medium having computer readable instructions embodied therein for executing a method for a referral system, comprising:
instructions for creating a vendor account for linking a vendor system with the referral system, the vendor system used for offering a vendor product and service;
instructions for establishing a referral rule based on which a user earns an amount from using the referral system;
instructions for establishing a threshold value based on which a user is permitted to redeem the amount earned by using the referral system;
instructions for creating a user account with the referral system that allows the user to electronically refer another entity to buy the vendor product and service;
instructions for sending an invitation to the another entity on behalf of the user, wherein the referral system sends the invite on the user's behalf with a review of the user's experience with vendor product and service;
based on the referral, instructions for crediting the user account, when the other entity makes a purchase of a product, service or both; and
instructions for redeeming the credited amount if the amount meets the threshold value set by the vendor.

14. The computer program product of claim 13, wherein the other entity is a user friend that is invited via a social network.

15. The computer program product of claim 13, wherein the vendor is a business entity.

16. The computer program product of claim 13, wherein the user posts a product, service, or a combination thereof review on a social networking site that is accessible to a plurality of user friends and based on the review a user friend makes a purchase.

17. The computer program product of claim 13, wherein the vendor maintains a minimum account balance to use the referral system.

18. The computer program product of claim 13, wherein the referral system displays a user dashboard such that the user can see an amount the user earned based on invitations sent on the user's behalf.
